(19) United States
(12) Patent Application Publication
(10) Pub. No.: US 2023/0138530 A1
(43) Pub. Date: May 4, 2023

(54) AUTONOMOUS VEHICLE, CONTROL SYSTEM FOR REMOTELY CONTROLLING THE SAME, AND METHOD THEREOF

(71) Applicants: Hyundai Motor Company, Seoul (KR); Kia Corporation, Seoul (KR)

(72) Inventor: Dong Hyuk KIM, Gyeonggi-Do (KR)

(73) Assignees: Hyundai Motor Company, Seoul (KR); Kia Corporation, Seoul (KR)

(21) Appl. No.: 17/724,136

(22) Filed: Apr. 19, 2022

(30) Foreign Application Priority Data
Nov. 3, 2021 (KR) 10-2021-0150019

(51) Int. Cl. G05D 1/00; B60W 60/00; H04N 7/18

(52) U.S. Cl. CPC G05D 1/0038; B60W 60/001; H04N 7/183; B60W 2556/45; B60W 2420/42

(57) ABSTRACT

An autonomous vehicle, a control system for remotely controlling the same, and a method thereof, includes an autonomous driving control apparatus including a processor that is configured for controlling remote driving for an autonomous vehicle by obtaining information related to a shaded section caused by a sensor failure according to surrounding information of the autonomous vehicle when receiving a remote driving control request and information related to the shaded section from the autonomous vehicle.

### CROSS-REFERENCE TO RELATED APPLICATION

The present application claims priority to Korean Patent Application No. 10-2021-0150019, filed on Nov. 3, 2021, the entire contents of which is incorporated herein for all purposes by this reference.

### BACKGROUND OF THE PRESENT DISCLOSURE

### Field of the Present Disclosure

The present disclosure relates to an autonomous vehicle, a control system for remotely controlling the same, and a method thereof, and more particularly, to a technique capable of performing remote control using a surrounding vehicle or surrounding environment when remote control of an autonomous vehicle is impossible.

### Description of Related Art

As an electronic technique of a vehicle develops, an interest in an autonomous vehicle that drives to a destination by recognizing a driving environment of the vehicle itself without manipulation of a driver is growing more and more.

An autonomous vehicle refers to a vehicle capable of operating by itself without manipulation of a driver or a passenger.

Such an autonomous vehicle may continue to drive by performing autonomous driving control or by performing remote driving control when it is difficult to performing the autonomous driving control. However, when a collision accident occurs during autonomous driving or remote driving, it is necessary to rapidly move an autonomous vehicle from an accident point to a safe area such as a shoulder to prevent secondary accidents.

However, when the sensor is damaged due to an accident, not only autonomous driving control but also remote control is impossible, so that the autonomous vehicle is left at the accident point, and thus there is a problem that it may be exposed to secondary accidents caused by other vehicles while driving.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an autonomous vehicle, a control system for remotely controlling the same, and a method thereof, configured for securing autonomous driving safety by moving a vehicle to a safe zone by performing temporary remote control using a surrounding vehicle and a surrounding environment when autonomous driving and remote driving are not possible due to an accident occurring during autonomous driving of the autonomous vehicle.

The technical objects of the present disclosure are not limited to the objects mentioned above, and other technical objects not mentioned may be clearly understood by those skilled in the art from the description of the claims.

Various aspects of the present disclosure are directed to providing a control system including an autonomous driving control apparatus including a processor that is configured for controlling remote driving for an autonomous vehicle by obtaining information related to a shaded section caused by a sensor failure according to surrounding information of the autonomous vehicle when receiving a remote driving control request and information related to the shaded section from the autonomous vehicle.

In an exemplary embodiment of the present disclosure, the surrounding information may include surrounding infrastructure information of the autonomous vehicle or information related to a surrounding vehicle positioned adjacent to the autonomous vehicle.

In an exemplary embodiment of the present disclosure, the processor may determine whether the autonomous vehicle is stopped for more than a predetermined time period by monitoring the autonomous vehicle, and when the processor concludes that the autonomous vehicle is stopped for more than the predetermined time period, requests checking whether remote driving is required to the autonomous vehicle.

In an exemplary embodiment of the present disclosure, the processor may generate a remote driving path for moving the autonomous vehicle from a current position of the autonomous vehicle to a safety zone, and determine an entire shaded section of the remote driving path.

In an exemplary embodiment of the present disclosure, the processor may determine whether a sensing range of a closed-circuit television (CCTV) around the autonomous vehicle includes the entire shaded section.

In an exemplary embodiment of the present disclosure, the processor, when the sensing range of the CCTV includes the entire shaded section, may generate a remote driving path of the autonomous vehicle according to image data of the CCTV.

In an exemplary embodiment of the present disclosure, the processor may request cooperation to a surrounding vehicle positioned around the autonomous vehicle.

In an exemplary embodiment of the present disclosure, the processor, may generate a driving path of the surrounding vehicle and transmitting the driving path to the surrounding vehicle when approval of the cooperation request is reached from the surrounding vehicle.

In an exemplary embodiment of the present disclosure, the processor may determine an entire shaded section on a remote driving path of the autonomous vehicle, and may generate the driving path of the surrounding vehicle so that a sensing range of the surrounding vehicle includes the entire shaded section.

In an exemplary embodiment of the present disclosure, the processor may divide the remote driving path of the autonomous vehicle into a plurality of sections, and may generate a driving path of the surrounding vehicle to be synchronized with the sections to transmit it to the surrounding vehicle when the surrounding vehicle is a vehicle that drives autonomously.

In an exemplary embodiment of the present disclosure, the processor, when the surrounding vehicle is a vehicle that drives autonomously, may control the surrounding vehicle to be positioned side by side in a lane next to the autonomous vehicle and to start simultaneously.

In an exemplary embodiment of the present disclosure, the processor, when the surrounding vehicle is a general driving vehicle which is directly driven by a driver, may generate some sections of the remote driving path of the autonomous vehicle as a driving path of the general vehicle, and may control the general vehicle to start driving first and the autonomous vehicle to start driving after a predetermined time period.

In an exemplary embodiment of the present disclosure, the processor, when a sensor of the autonomous vehicle malfunctions due to an accident of the autonomous vehicle, may generate a remote driving path for moving the autonomous vehicle from an accident point to a safety zone.

Various aspects of the present disclosure are directed to providing an autonomous vehicle, including a processor configured to request remote driving control to a control system to transmit information related to a shaded section, and to receive a remote driving path from the control system and follows the remote driving path when a shaded section occurs due to a sensor failure during autonomous driving of the autonomous vehicle.

In an exemplary embodiment of the present disclosure, the processor, when a sensor of the autonomous vehicle malfunctions due to an accident of the autonomous vehicle, may move it from an accident point to a safe zone depending on the remote driving path received from the control system.

Various aspects of the present disclosure are directed to providing a remote control method for an autonomous vehicle, including: receiving a remote driving control request and information related to a shaded section due to a sensor failure from the autonomous vehicle; and controlling remote driving of the autonomous vehicle by obtaining information related to the shaded section according to surrounding information of the autonomous vehicle.

In an exemplary embodiment of the present disclosure, the controlling of the remote driving may include: generating a remote driving path for moving the autonomous vehicle from a current position of the autonomous vehicle to a safety zone, and determining an entire shaded section of the remote driving path; and determining whether a sensing range of a CCTV around the autonomous vehicle includes the entire shaded section.

In an exemplary embodiment of the present disclosure, the controlling of the remote driving may further include: when the sensing range of the CCTV includes the entire shaded section, generating a remote driving path of the autonomous vehicle according to image data of the CCTV.

In an exemplary embodiment of the present disclosure, the controlling of the remote driving may further include: when the sensing range of the CCTV does not include the entire shaded section, requesting cooperation to a surrounding vehicle positioned around the autonomous vehicle; and generating a driving path of the surrounding vehicle and transmitting the driving path to the surrounding vehicle when approval of the cooperation request is reached from the surrounding vehicle.

In an exemplary embodiment of the present disclosure, the controlling of the remote driving may further include: determining an entire shaded section on a remote driving path of the autonomous vehicle, and generating the driving path of the surrounding vehicle so that a sensing range of the surrounding vehicle includes the entire shaded section; dividing the remote driving path of the autonomous vehicle into a plurality of sections, and generating a driving path of the surrounding vehicle to be synchronized with the sections when the surrounding vehicle is a vehicle that drives autonomously; when the surrounding vehicle is a general driving vehicle which is directly driven by a driver, generating some sections of the remote driving path of the autonomous vehicle as a driving path of the general vehicle; and controlling the general vehicle to start driving first and the autonomous vehicle to start driving after a predetermined time period.

According to the present technique, it is possible to secure autonomous driving safety by moving a vehicle to a safe zone by performing temporary remote control using a surrounding vehicle and a surrounding environment when autonomous driving and remote driving are not possible due to an accident occurring during autonomous driving, improving autonomous driving commercialization.

Furthermore, various effects which may be directly or indirectly identified through the present specification may be provided.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a block diagram showing a configuration of a system for remotely controlling an autonomous vehicle according to various exemplary embodiments of the present disclosure.

FIG. 2 illustrates a view for describing a sensing device of an autonomous vehicle according to various exemplary embodiments of the present disclosure.

FIG. 3 illustrates a sensing range of a sensing device of an autonomous vehicle according to various exemplary embodiments of the present disclosure.

FIG. 4 illustrates an example for describing a shaded section due to damage to a sensor of an autonomous vehicle according to various exemplary embodiments of the present disclosure.

FIG. 5 illustrates an example of a remote driving path for moving an autonomous vehicle in which an accident has occurred to a safe zone using surrounding CCTV information according to various exemplary embodiments of the present disclosure.

FIG. 6 illustrates an example of a remote driving path for moving an autonomous vehicle in which an accident has occurred to a safe zone using a surrounding autonomous vehicle according to various exemplary embodiments of the present disclosure.

FIG. 7 illustrates an example of synchronizing a path of an autonomous vehicle in which an accident has occurred with a path of a surrounding autonomous vehicle according to various exemplary embodiments of the present disclosure.

FIG. 8 illustrates an example of paths of a surrounding general vehicle and an autonomous vehicle in which an accident has occurred according to various exemplary embodiments of the present disclosure.

FIG. 9 illustrates a flowchart showing a process of remotely controlling an autonomous vehicle based on surrounding information when an accident occurs in the autonomous vehicle according to various exemplary embodiments of the present disclosure.

FIG. 10 illustrates a flowchart detailing a process of remotely controlling an autonomous vehicle by use of surrounding information when an accident occurs in the autonomous vehicle according to various exemplary embodiments of the present disclosure.

FIG. 11 illustrates a computing system according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, some exemplary embodiments of the present disclosure will be described in detail with reference to exemplary drawings. It should be noted that in adding reference numerals to constituent elements of each drawing, the same constituent elements have the same reference numerals as possible even though they are indicated on different drawings. Furthermore, in describing exemplary embodiments of the present disclosure, when it is determined that detailed descriptions of related well-known configurations or functions interfere with understanding of the exemplary embodiments of the present disclosure, the detailed descriptions thereof will be omitted.

In describing constituent elements according to various exemplary embodiments of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field of the present disclosure to which an exemplary embodiment of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

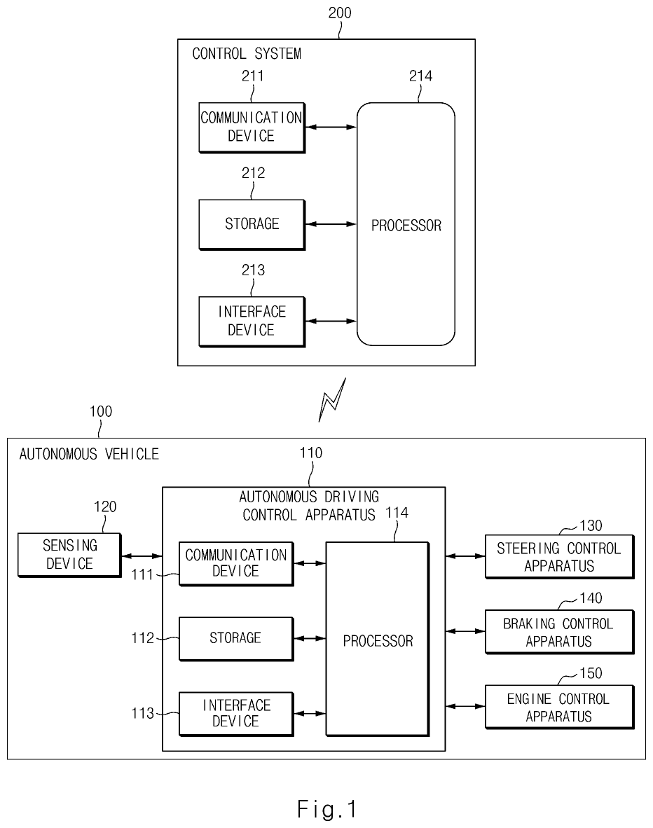

Hereinafter, various exemplary embodiments of the present disclosure will be described in detail with reference to FIG. 1 to FIG. 10.

FIG. 1 illustrates a block diagram showing a configuration of a system for remotely controlling an autonomous vehicle according to various exemplary embodiments of the present disclosure.

Referring to FIG. 1, the remote control system for an autonomous vehicle according to various exemplary embodiments of the present disclosure includes an autonomous vehicle 100 and a control system 200, and remote control may be performed through communication between the autonomous vehicle 100 and the control system 200. In the instant case, the autonomous vehicle 100 may include a vehicle that autonomously drives regardless of presence of an occupant.

The autonomous vehicle 100 may include an autonomous driving control apparatus 120, a sensing device 120, a steering control apparatus 130, a braking control apparatus 140, and an engine control apparatus 150.

The autonomous driving control apparatus 110 according to the exemplary embodiment of the present disclosure may be implemented inside the vehicle. In the instant case, the autonomous driving control apparatus 110 may be integrally formed with internal control units of the vehicle, or may be implemented as a separate device to be connected to control units of the vehicle by a separate connection means.

When a sensor failure occurs due to a collision accident or the like during autonomous driving, the autonomous driving control apparatus 110 determines a shaded section that occurs due to the sensor failure, and requests remote driving control to the control system 200. In the instant case, the autonomous driving control apparatus 110 may transmit the information related to the shaded section to the control system 200, and the control system 200 may generate a remote driving path in consideration of the shaded section by use of surrounding information (peripheral infrastructure information and surrounding vehicle information) to transmit it to the autonomous driving control apparatus 110, making it possible to follow and move a remote driving route from an accident point to a safe area such as a shoulder.

Referring to FIG. 1, the autonomous driving control apparatus 110 may include a communication device 111, a storage 112, an interface device 113, and a processor 114.

The communication device 111 is a hardware device implemented with various electronic circuits to transmit and receive signals through a wireless or wired connection, and may transmit and receive information based on in-vehicle devices and in-vehicle network communication techniques. As an exemplary embodiment of the present disclosure, the in-vehicle network communication techniques may include controller area network (CAN) communication, Local Interconnect Network (LIN) communication, flex-ray communication, Ethernet communication, and the like.

Furthermore, the communication device 111 may perform communication by use of a server, infrastructure, or third vehicles outside the vehicle, and the like through a wireless Internet technique or short range communication technique. Herein, the wireless Internet technique may include wireless LAN (WLAN), wireless broadband (Wibro), Wi-Fi, Worldwide Interoperability for Microwave Access (WiMAX), Ethernet communication, etc. Furthermore, short-range communication technique may include Bluetooth, ZigBee, ultra wideband (UWB), radio frequency identification (RFID), infrared data association (IrDA), and the like. For example, the communication device 111 may perform wireless communication with the control system 200, may transmit vehicle position information (e.g., vehicle coordinates), surrounding information (e.g., obstacle information), vehicle information (e.g., vehicle internal and external image data, etc.), shaded section information due to the sensor failure, etc. To the control system 200, and may receive a remote driving path, a remote driving control command, and the like from the control system 200.

The storage 112 may store sensing results of the sensing device 120, information received from the control system 200, data and/or algorithms required for the processor 114 to operate, and the like. As an exemplary embodiment of the present disclosure, the storage 112 may store vehicle information, image data captured through a camera, a command received from the control system 200, etc.

The storage 112 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 113 may include an input means for receiving a control command from a user and an output means for outputting an operation state of the autonomous driving control apparatus 110 and results thereof. Herein, the input means may include a key button, and may further include a mouse, a keyboard, a touch screen, a microphone, a joystick, a jog shuttle, a stylus pen, and the like. Furthermore, the input means may further include a soft key implemented on the display.

The output means may include a display, and may further include a voice output means such as a speaker. In the instant case, when a touch sensor formed of a touch film, a touch sheet, or a touch pad is provided on the display, the display may operate as a touch screen, and may be implemented in a form in which an input device and an output device are integrated. For example, the output device may output a current situation of the autonomous vehicle 100, such as an autonomous driving impossible situation, an autonomous driving re-start situation, a remote driving control situation, and the like.

In the instant case, the display may include at least one of a liquid crystal display (LCD), a thin film transistor liquid crystal display (TFT LCD), an organic light emitting diode display (OLED display), a flexible display, a field emission display (FED), or a 3D display.

As an exemplary embodiment of the present disclosure, the interface device 113 may be implemented as a head-up display (HUD), a cluster, an audio video navigation (AVN), a human machine interface (HM), a user setting menu (USM), or the like.

The processor 114 may be electrically connected to the communication device 111, the storage 112, the interface device 113, and the like, may electrically control each component, and may be an electrical circuit that executes software commands, performing various data processing and calculations described below.

The processor 114 may process a signal transferred between components of the autonomous driving control apparatus 110, and may perform overall control so that each of the components can perform its function normally.

The processor 114 may be implemented in a form of hardware, software, or a combination of hardware and software, or may be implemented as microprocessor, and may be, e.g., an electronic control unit (ECU), a micro controller unit (MCU), or other subcontrollers mounted in the vehicle.

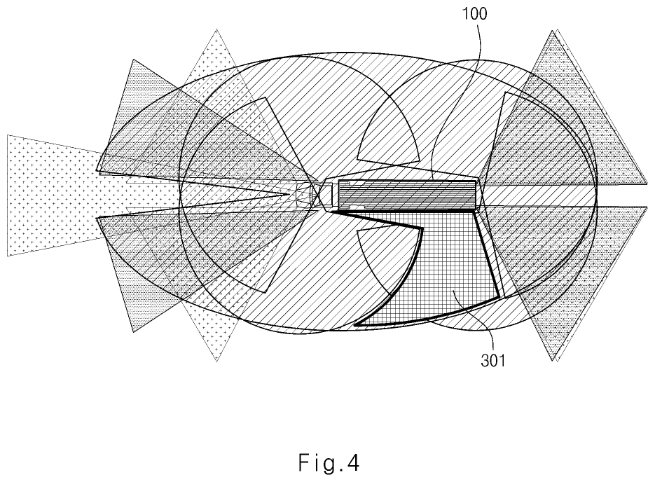

The processor 114 determines whether there is a sensor failure due to a collision accident or the like during autonomous driving, and when the sensor failure occurs, determines that autonomous driving control is impossible. Next, the processor 114 may determine a shaded section due to the sensor failure. In the instant case, the processor 114 may determine a section in which information is not obtained due to a malfunctioning sensor as shown in FIG. 4 as a shaded section 301. FIG. 4 illustrates an example for describing a shaded section due to damage to a sensor of an autonomous vehicle according to various exemplary embodiments of the present disclosure.

When a shaded section exists due to the sensor failure, the processor 114 determines that autonomous driving is impossible, requests remote driving control to the control system 200, and transmits information related to the shaded section. Thereafter, the processor 114 follows and controls a remote driving path received from the control system 200.

The sensing device 120 may include one or more sensors that detect an obstacle, e.g., a preceding vehicle, positioned around the host vehicle and measure a position of the obstacle, a distance therewith and/or a relative speed thereof.

The sensing device 120 may include a plurality of sensors to detect an external or internal object of the vehicle, to obtain information related to a position of the external object, a speed of the external object, a moving direction of the external object, and/or a type of the external object (e.g., animals, vehicles, pedestrians, bicycles, or motorcycles, etc.). To the present end, the sensing device 120 may include an ultrasonic detector, a radar, a camera (inside and outside the vehicle), a laser scanner and/or a corner radar, a Light Detection and Ranging (LiDAR), an acceleration detector, and the like.

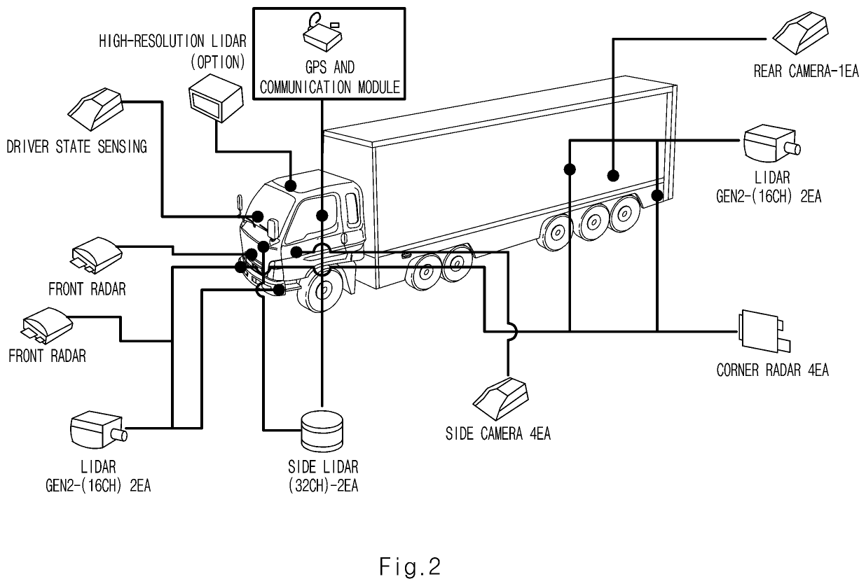

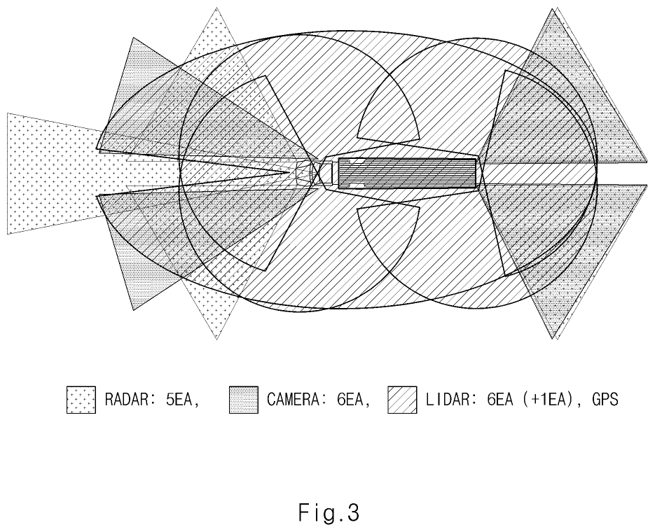

FIG. 2 illustrates a view for describing a sensing device of an autonomous vehicle according to various exemplary embodiments of the present disclosure, and FIG. 3 illustrates a sensing range of a sensing device of an autonomous vehicle according to various exemplary embodiments of the present disclosure.

Referring to FIG. 2, the sensing device 120 may include a front radar mounted on the front of the vehicle, a Light Detection and Ranging (LiDAR), a side LiDAR, a side camera, a corner radar, a high-resolution LiDAR, a rear camera, a rear LiDAR, etc. Furthermore, referring to FIG. 3, a surrounding situation may be detected through radars, cameras, and LiDARs of the front, rear, and side of the vehicle.

The steering control device 130 may be configured to control a steering angle of a vehicle, and may include a steering wheel, an actuator interlocked with the steering wheel, and a controller configured for controlling the actuator.

The braking control device 140 may be configured to control braking of the vehicle, and may include a controller that is configured to control a brake thereof.

The engine control unit (ECU) 150 may be configured to control engine driving of a vehicle, and may include a controller that is configured to control a speed of the vehicle.

When receiving a remote driving control request from an autonomous vehicle due to a sensor failure, the control system 200 generates a remote driving path in consideration of the shaded section due to the sensor failure. In the instant case, the control system 200 may generate a remote driving path based on surrounding information to transmit it to the autonomous vehicle 100, and when receiving cooperation from a surrounding vehicle, may generate a driving path of the surrounding vehicle together to transmit the driving path to the surrounding vehicle.

The control system 200 may include a communication device 211, a storage 212, an interface device 213, and a processor 214.

The communication device 211 is a hardware device implemented with various electronic circuits to transmit and receive signals through a wireless or wired connection, and may transmit and receive information based on in-vehicle devices and in-vehicle network communication techniques. As an exemplary embodiment of the present disclosure, the in-vehicle network communication techniques may include controller area network (CAN) communication, Local Interconnect Network (LIN) communication, flex-ray communication, Ethernet communication, and the like.

Furthermore, the communication device 211 may perform communication by use of a server, infrastructure, or third vehicles outside the vehicle, and the like through a wireless Internet technique or short range communication technique. Herein, the wireless Internet technique may include wireless LAN (WLAN), wireless broadband (Wibro), Wi-Fi, Worldwide Interoperability for Microwave Access (WiMAX), etc. Furthermore, short-range communication technique may include Bluetooth, ZigBee, ultra wideband (UWB), radio frequency identification (RFID), infrared data association (IrDA), and the like. For example, the communication device 211 may perform wireless communication with the autonomous vehicle 100. For example, the communication device 2110 may communicate with an infrastructure or a surrounding vehicle of the autonomous vehicle 100.

The storage 212 may store information received from the autonomous vehicle 100, and data and/or algorithm required for the processor 214 to operate, and the like. As an exemplary embodiment of the present disclosure, the storage 212 may store information related to the shaded section and vehicle position information received from the autonomous vehicle 100, etc.

The storage 212 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 213 may include an input means configured for receiving a control command from an operator and an output means for outputting an operation state of the control system 200 and results thereof. Herein, the input means may include a key button, and may further include a mouse, a keyboard, a touch screen, a microphone, a joystick, a jog shuttle, a stylus pen, and the like. Furthermore, the input means may further include a soft key implemented on the display. For example, the interface device 213 may display a remote driving control situation, and may receive a remote driving control command from an operator. Furthermore, the interface device 213 may include all communication terminals such as a personal computer (PC), a notebook computer, a smartphone, a tablet PC, a pad, a personal digital assistant (PDA), and a wearable device.

The output means may include a display, and may further include a voice output means such as a speaker. In the instant case, when a touch sensor formed of a touch film, a touch sheet, or a touch pad is provided on the display, the display may operate as a touch screen, and may be implemented in a form in which an input device and an output device are integrated.

In the instant case, the display may include at least one of a liquid crystal display (LCD), a thin film transistor liquid crystal display (TFT LCD), an organic light emitting diode display (OLED display), a flexible display, a field emission display (FED), or a 3D display.

The processor 214 may be electrically connected to the communication device 211, the storage 212, the interface device 213, and the like, may electrically control each component, and may be an electrical circuit that executes software commands, performing various data processing and calculations described below.

The processor 214 may process a signal transferred between components of the control system 200, and may perform overall control so that each of the components can perform its function normally. The processor 214 may be implemented in a form of hardware, software, or a combination of hardware and software, or may be implemented as microprocessor.

The processor 214 may determine whether the autonomous vehicle 100 is stopped for more than a predetermined time period by monitoring the autonomous vehicle 100, and when the autonomous vehicle 100 is stopped for more than the predetermined time period, may request check of whether remote driving is required to the autonomous vehicle 100.

The processor 214 may periodically collect vehicle information (e.g., a vehicle position, vehicle surrounding image data, etc.) from the autonomous vehicle 100, may collect image information such as an image of a CCTV around the autonomous vehicle 100, and may generate a remote driving path of the autonomous vehicle 100 based on the collected information.

The processor 214 may generate a remote driving path for moving from a current position of the autonomous vehicle 100 to a safety zone (e.g., a shoulder to avoid a secondary collision accident, etc.), and may determine an entire shaded section of the remote driving path.

The processor 214 may determine whether a sensing range of the CCTV around the autonomous vehicle 100 includes the entire shaded section.

When the sensing range of the CCTV includes the entire shaded section, the processor 214 may generate a remote driving path of the autonomous vehicle 100 based on image data of the CCTV.

When it is difficult to generate the remote driving path based on the CCTV, the processor 214 may request cooperation to a surrounding vehicle positioned around the autonomous vehicle 100. In the instant case, the surrounding vehicle may be positioned in a lane next to the autonomous vehicle 100, may be positioned within a predetermined distance, and may be positioned in a point configured for covering the shaded section of the autonomous vehicle 100.

Accordingly, the processor 214 may transmit a cooperation request to the surrounding vehicle, and may receive approval or rejection of the cooperation request from the surrounding vehicle.

When the approval for the cooperation request is received from the surrounding vehicle, the processor 214 generates a driving path of the surrounding vehicle in consideration of the shaded section of the autonomous vehicle 100 to transmit the driving path to the surrounding vehicle. That is, the processor 214 may determine an entire shaded section on the remote driving path of the autonomous vehicle 100, and may generate the driving path of the surrounding vehicle so that a sensing range of the surrounding vehicle includes the entire shaded section. When the surrounding vehicle is a vehicle that autonomously drives, that is, when the surrounding vehicle is also an autonomous vehicle, the processor 214 may generate the driving path of the surrounding vehicle by synchronizing it with the remote driving path of the autonomous vehicle 100 in which the accident has occurred.

That is, the processor 214 may divide the remote driving path of the autonomous vehicle 100 into a plurality of sections, may generate a driving path of the surrounding vehicle to be synchronized with the sections, and may transmit the driving path to the surrounding vehicle.

When the surrounding vehicle is a vehicle that autonomously drives, the processor 214 may control the surrounding vehicle to be positioned side by side in a lane next to the autonomous vehicle 100 and to start at the same time.

On the other hand, when the surrounding vehicle is a general vehicle which is directly driven by a driver, the processor 214 may generate some sections of the remote driving path of the autonomous vehicle 100 as a driving path of the general vehicle, and may control the general vehicle to start driving first and the autonomous vehicle 100 to start driving after a predetermined time period.

Accordingly, when a sensor fails due to occurrence of an accident of the autonomous vehicle 100, the processor 214 may generate a remote driving route for moving the autonomous vehicle 100 from an accident point to a safe zone by use of surrounding information, increasing autonomous driving safety.

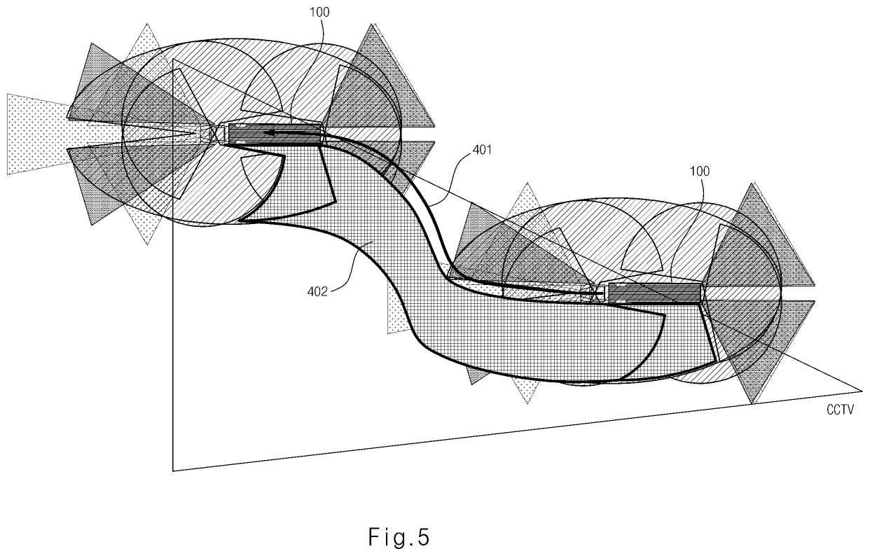

FIG. 5 illustrates an example of a remote driving path for moving an autonomous vehicle in which an accident has occurred to a safe zone using surrounding CCTV information according to various exemplary embodiments of the present disclosure.

Referring to FIG. 5, the control system 200 may select the entire shaded section 402 on the remote driving route 401 for moving the autonomous vehicle 100 to a safe zone such as a shoulder.

Next, the control system 200 determines whether detection of an entire shaded section 402 is possible by use of surrounding infrastructure information, and when the detection of the shaded section 402 is possible, controls remote driving for moving the autonomous vehicle 100 to the safe zone based on the surrounding infrastructure information.

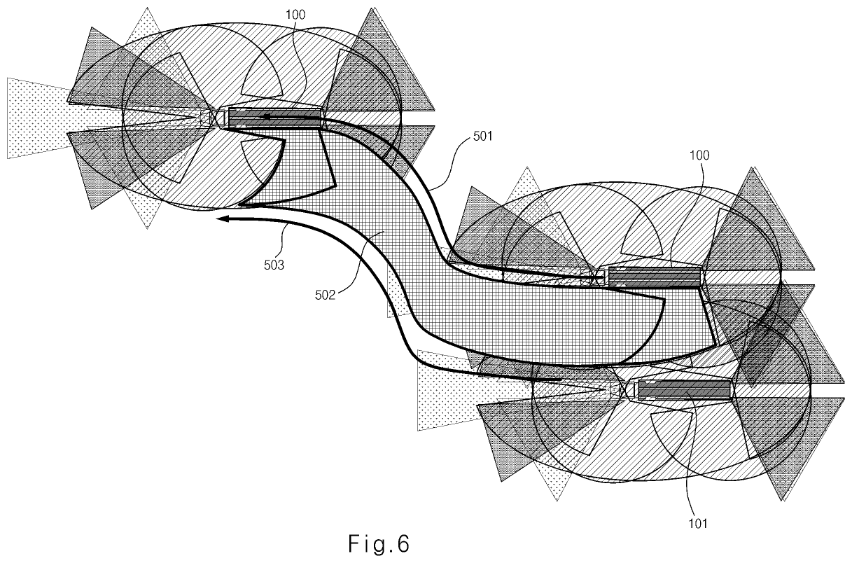

FIG. 6 illustrates an example of a remote driving path for moving an autonomous vehicle in which an accident has occurred to a safe zone using a surrounding autonomous vehicle according to various exemplary embodiments of the present disclosure.

Referring to FIG. 6, the control system 200 may generate a remote driving path 501 for the autonomous vehicle 100 to move from a current position to a safe zone and may select an entire shaded section 502 when it drives on the remote driving path 501, and then may receive sensing information related to the entire shaded section 502 from a surrounding vehicle 101. That is, the control system 200 generates a driving route 503 of the surrounding vehicle 101 by requesting cooperation to the surrounding vehicle 101 so that the surrounding vehicle 101 can drive side by side on a lane next to the autonomous vehicle 100. Accordingly, the control system 200 may cover the entire shaded section 502 caused by a malfunction of a left sensor of the autonomous vehicle 100 based on sensing information of a right sensor of the surrounding vehicle 101. That is, the control system 200 may obtain information of the entire shaded section 502 based on the sensing information of the right sensor of the surrounding vehicle 101 to enable remote driving control of the autonomous vehicle 100.

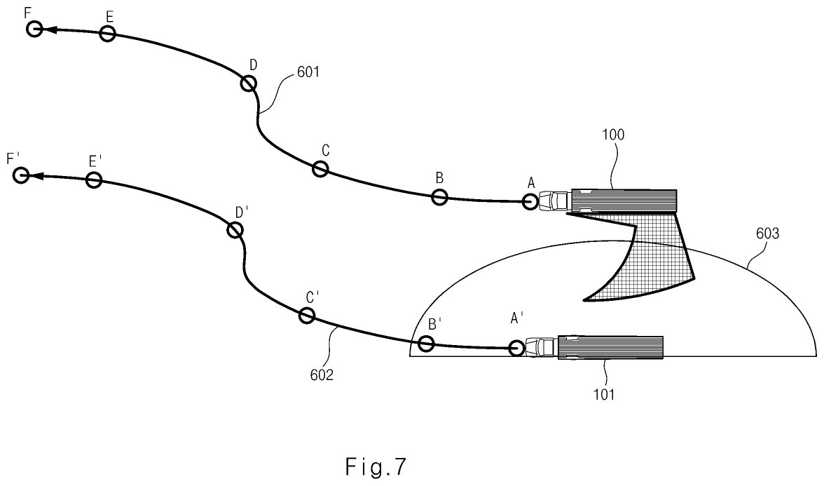

FIG. 7 illustrates an example of synchronizing a path of an autonomous vehicle in which an accident has occurred with a path of a surrounding autonomous vehicle according to various exemplary embodiments of the present disclosure.

Referring to FIG. 7, a remote driving path 601 from a current position, which is an accident point of the autonomous vehicle 100 to a safety zone, may be generated, and a driving path 602 of the surrounding vehicle 101 may be generated so that a sensing range 603 of a sensor of the surrounding vehicle 101 which is an autonomous vehicle covers the entire shaded section of the autonomous vehicle 100. In the instant case, the remote driving path 601 of the autonomous vehicle 100 may be divided into a plurality of sections A, B, C, D, E, F, G, and H, the driving route 602 of the surrounding vehicle 101 is divided into a plurality of sections A′, B′, C′, D′, E′, F′, G′, and H′, and the driving path 602 may be generated so that the sections A, B, C, D, E, F, G, and H of the remote driving path 601 and the sections A′, B′, C′, D′, E′, F′, G′, and H′ of the driving path 602 are synchronized for each section.

Accordingly, the control system 200 transmits the synchronized driving path 602 to the surrounding vehicle 101, and the surrounding vehicle 101 follows and controls the synchronized driving path 602. Accordingly, the autonomous vehicle 100 and the surrounding vehicle 101 may simultaneously start from the starting sections A and A′, and in the present way, the autonomous vehicle 100 may move to the safe zone.

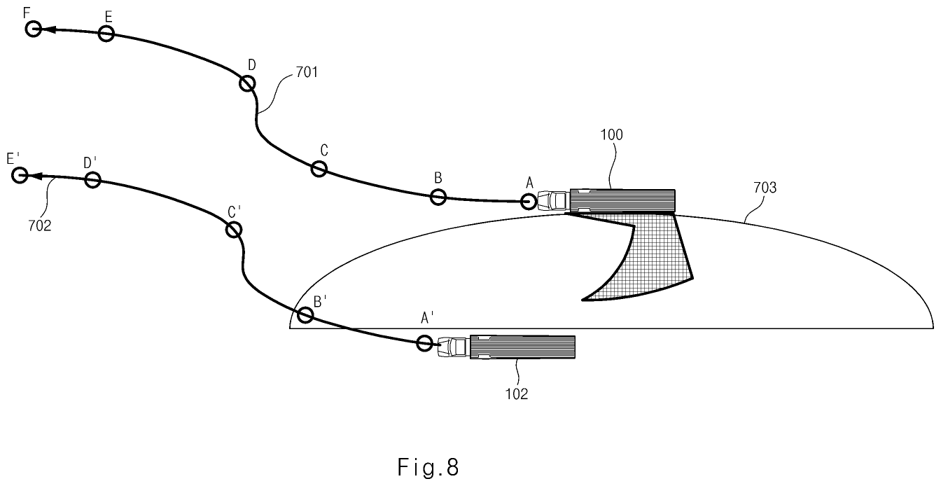

FIG. 8 illustrates an example of paths of a surrounding general vehicle and an autonomous vehicle in which an accident has occurred according to various exemplary embodiments of the present disclosure.

Referring to FIG. 8, a remote driving path 701 from a current position, which is an accident point of the autonomous vehicle 100 to a safety zone, may be generated, and a driving path 702 of the surrounding vehicle 102 may be generated so that a sensing range 703 of a sensor of the surrounding vehicle 102 which is a general vehicle covers the entire shaded section of the autonomous vehicle 100. In the instant case, the general vehicle includes a vehicle which is directly driven by a driver. Accordingly, the driving path 702 may be generated as much as a distance which is available to the driver of the surrounding vehicle 102.

In the instant case, the remote driving path 701 of the autonomous vehicle 100 may be divided into a plurality of sections A, B, C, D, E, F, G, and H, the driving route 702 of the surrounding vehicle 102 is divided into a plurality of sections A′, B′, C′, D′, and E′, and the driving path 702 may be generated so that the sections A, B, C, D, E, F, G, and H of the remote driving path 701 and the sections A′, B′, C′, D′, and E′ of the driving path 702 are synchronized for each section. FIG. 7 illustrates an example in which the distance available to the driver, i.e., the driving path 702 is shorter than the remote driving path 701.

The control system 200 may control the driver of the surrounding vehicle 102 to start driving first in accordance with the received driving path 702 and control the autonomous vehicle 100 to follow it in a next lane by transmitting the driving path 702 to the surrounding vehicle 102.

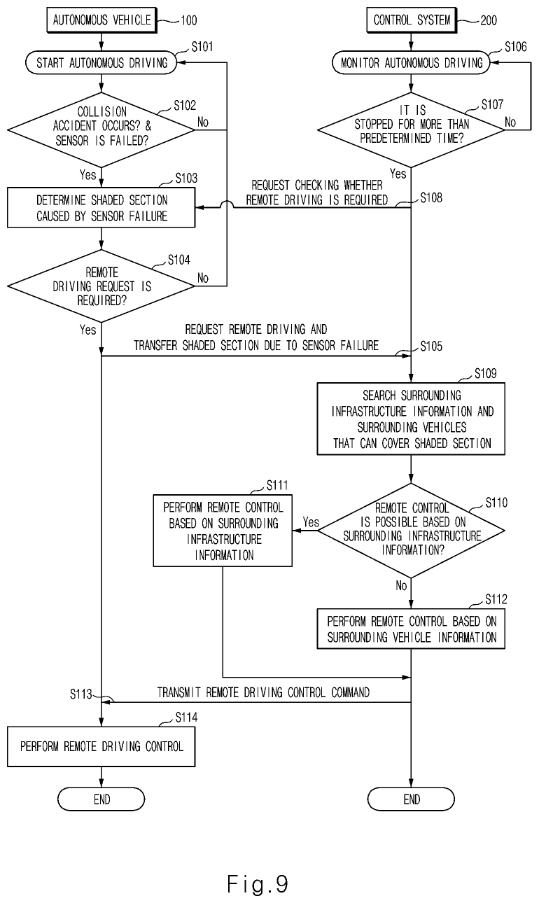

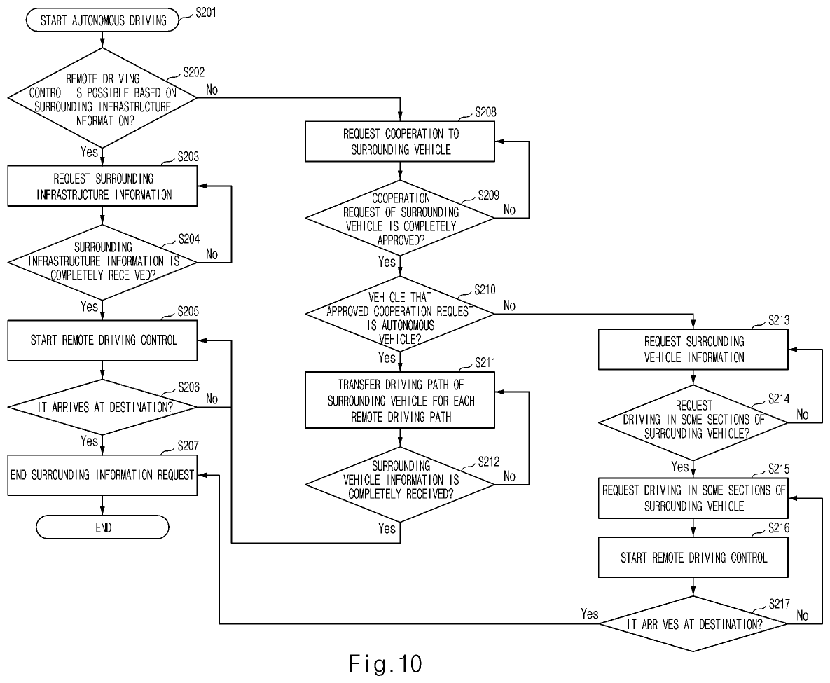

Hereinafter, a method for remote control based on surrounding information in the event of an accident of an autonomous vehicle according to various exemplary embodiments of the present disclosure will be described in detail with reference to FIG. 9 and FIG. 10. FIG. 9 illustrates a flowchart showing a process of remotely controlling an autonomous vehicle based on surrounding information when an accident occurs in the autonomous vehicle according to various exemplary embodiments of the present disclosure, and FIG. 10 illustrates a flowchart detailing a process of remotely controlling an autonomous vehicle by use of surrounding information when an accident occurs in the autonomous vehicle according to various exemplary embodiments of the present disclosure.

Hereinafter, it is assumed that the autonomous driving control apparatus 110 and the control system 200 of the autonomous vehicle 100 of FIG. 1 perform the processes of FIG. 9, and it is assumed that the control system 200 performs the processes of FIG. 10. Furthermore, in the description of FIG. 9 and FIG. 10, it may be understood that operations referred to as being performed by each device and system are controlled by a processor of each of the systems.

Referring to FIG. 9, the autonomous vehicle 100 starts autonomous driving upon receiving an autonomous driving command from the control system 200 (S101).

Thereafter, it is determined whether a collision accident of the autonomous vehicle 100 has occurred and whether a sensor has failed (S102).

A shaded section caused by sensor failure is determined in the case of sensor failure due to occurrence of a collision accident of the autonomous vehicle 100. As illustrated in FIG. 4, when a left sensor of the autonomous vehicle 100 fails, a shaded section 301 which is not detected is generated at a left side thereof.

Accordingly, the autonomous vehicle 100 determines whether a remote driving request is required based on the shaded section (S104), and when it is determined that the remote driving request is required due to the shaded section, requests remote driving to the control system 200 (S105). In the instant case, the autonomous vehicle 100 transmits information related to the shaded section due to the sensor failure when requesting the remote driving request to the control system 200.

Meanwhile, the control system 200 monitors the autonomous vehicle 100 (S106), and determines whether the autonomous vehicle 100 is stopped for more than a predetermined time period (S107).

When the autonomous vehicle 100 is stopped for more than the predetermined time period, the control system 200 may determine that the autonomous vehicle 100 is stopped due to a collision accident, etc., and may request checking whether remote driving is required to the autonomous vehicle 100 (S108).

On the other hand, when receiving a remote driving request from the autonomous vehicle 100, the control system 200 searches surrounding infrastructure information and surrounding vehicles that can cover the shaded section by receiving shaded section information together (S109). In the instant case, the surrounding infrastructure information includes image information such as a CCTV around the autonomous vehicle 100, and the surrounding vehicle may include a vehicle positioned within a predetermined distance from the autonomous vehicle 100.

Accordingly, the control system 200 determines whether remote control is possible based on the surrounding infrastructure information (S110), when the remote control is possible based on the surrounding infrastructure information, performs the remote control based on the surrounding infrastructure information (S111), and when the remote control is possible based on the surrounding infrastructure information, performs the remote control based on surrounding vehicle information (S112).

Accordingly, the control system 200 transmits a remote driving control command to the autonomous vehicle 100 so that the autonomous vehicle 100 in which an accident has occurred moves to a safe zone (e.g., a shoulder) based on the surrounding infrastructure information or the surrounding vehicle information (S113).

Next, the autonomous vehicle 100 moves to the safe zone by driving depending on the remote driving control command received from the control system 200 (S114).

Hereinafter, a remote driving control process based on cooperation of the surrounding information of the control system 200 will be described in detail with reference to FIG. 10.

Referring to FIG. 10, the control system 200 starts a process of requesting surrounding information from surrounding infrastructure and surrounding vehicles (S201). In the instant case, the surrounding information may include surrounding infrastructure information and surrounding vehicle information. The surrounding infrastructure information may include image information such as an image of a CCTV, etc., and the surrounding vehicle information may include information such as a position, a path, and a speed of a vehicle positioned close to the autonomous vehicle 100.

The control system 200 determines whether remote driving control of the autonomous vehicle 100 is possible based on the surrounding infrastructure information (S202), and when remote driving is possible based on the surrounding infrastructure information, requests the surrounding infrastructure information to the surrounding infrastructure (S203). That is, the control system 200 may determine whether there is a surrounding infrastructure such as a CCTV around the autonomous vehicle 100, and when there is the surrounding infrastructure, may determine that remote driving control of the autonomous vehicle 100 is possible based on the surrounding infrastructure information.

The control system 200 checks whether the surrounding infrastructure information is completely received (S204), and when the surrounding infrastructure information is completely received, starts remote driving control for the autonomous vehicle 100 (S205).

Thereafter, the control system 200 checks whether the autonomous vehicle 100 has arrived at a destination thereof (S205), and terminates the request for information related to the surrounding infrastructure when it has arrived at the destination (S207).

That is, the control system 200 may perform remote control so that the autonomous vehicle 100 moves to a safe zone such as a shoulder based on the surrounding infrastructure information in a state where the autonomous vehicle 100 is stopped after an accident, and may periodically request and receive the surrounding infrastructure information.

When the remote driving is impossible based on the surrounding infrastructure information in step S202, that is, when there is no infrastructure such as a CCTV close to the autonomous vehicle 100, the control system 200 may request cooperation to a vehicle surrounding the autonomous vehicle 100 (S208). In the instant case, when receiving a request for cooperation from the control system 200, the surrounding vehicle may approve or reject the request.

Thereafter, the control system 200 determines whether an approval of the cooperation request from the surrounding vehicle is completed (S209).

The control system 200 determines whether the vehicle approved for the cooperation request is an autonomous vehicle (S210).

When the vehicle approved for the cooperation request is an autonomous vehicle, the control system 200 synchronizes a remote driving path of the autonomous vehicle 100 with a driving path of the surrounding vehicle approved for the cooperation request, to transmit it to the surrounding vehicle (S211). Next, the surrounding vehicle may follow and control the driving path received from the control system 200 to recognize the shaded section of the autonomous vehicle 100 by use of sensor information of the surrounding vehicle. As illustrated in FIG. 7, a remote driving path of the autonomous vehicle 100 to a safety zone is divided into a plurality of sections A to F, and a driving path of the surrounding vehicle 101, which is an autonomous vehicle, is generated by synchronizing it to correspond to each of the sections of the autonomous vehicle 100.

Thereafter, the control system 200 determines whether surrounding vehicle information is completely received (S212), and starts remote driving control when the surrounding vehicle information is completely received (S205). Thereafter, the control system 200 checks whether the autonomous vehicle 100 has arrived at a destination thereof (S205), and terminates the request for information related to the surrounding infrastructure when it has arrived at the destination (S207).

On the other hand, when the vehicle approved for the cooperation request in step S210 is a general vehicle rather than an autonomous vehicle, the control system 200 requests information to the surrounding vehicle, which is a general vehicle (S213).

The control system 200 determines whether the information related to the surrounding vehicle, which is the vehicle, is completely received (S214), and when the information related to the surrounding vehicle, which is the vehicle, is completely received, requests driving in some sections of the surrounding vehicle. As illustrated in FIG. 8, the control system 200 may partially synchronize the driving path of the surrounding vehicle, which is the general vehicle, with the remote driving path of the autonomous vehicle 100, and in the instant case, may control a surrounding vehicle 102 to start first and the autonomous vehicle 100 to travel at a predetermined distance from the surrounding vehicle 102.

Thereafter, the control system 200 starts driving of the surrounding vehicle, which is the general vehicle, and starts remote driving control of the autonomous vehicle 100 (S216).

Next, the control system 200 checks whether the autonomous vehicle 100 has arrived at a destination thereof (S217), and terminates the request for surrounding information when it has arrived at the destination (S207).

Accordingly, when an accident of the autonomous vehicle occurs, the control system 200 in an exemplary embodiment of the present disclosure may move the autonomous vehicle to a safe zone, such as a shoulder, out of an accident site by remote driving. In the instant case, when a sensor malfunction occurs due to an accident, it is possible to remotely control the autonomous vehicle to move to the safe zone based on surrounding infrastructure information and surrounding vehicle information. Accordingly, according to an exemplary embodiment of the present disclosure, it is possible to prevent secondary accidents and to secure stability of autonomous driving by minimizing a condition in which remote driving is impossible in an emergency situation.

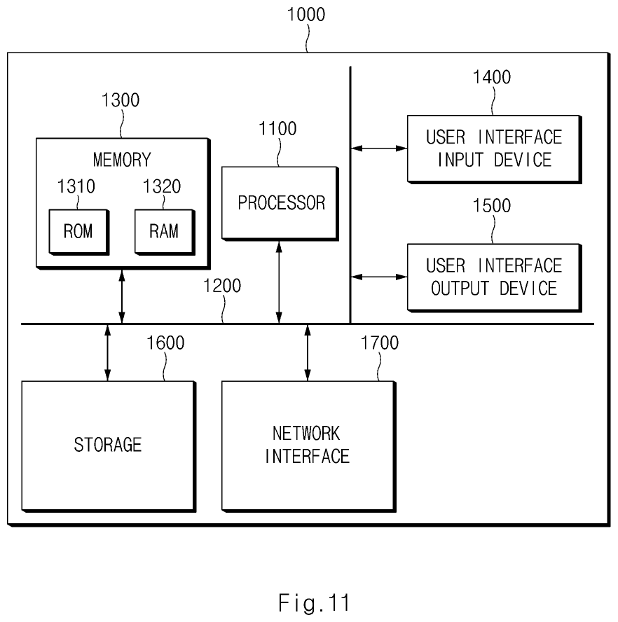

FIG. 11 illustrates a computing system according to various exemplary embodiments of the present disclosure.

Referring to FIG. 11, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which an exemplary embodiment of the present disclosure pertains may make various modifications and variations without departing from the essential characteristics of the present disclosure.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A control system comprising
an autonomous driving control apparatus including a processor that is configured for controlling remote driving for an autonomous vehicle by obtaining information related to a shaded section caused by a sensor failure according to surrounding information of the autonomous vehicle when receiving a remote driving control request and information related to the shaded section from the autonomous vehicle.

2. The control system of claim 1, wherein the surrounding information includes surrounding infrastructure information of the autonomous vehicle or information related to a surrounding vehicle positioned adjacent to the autonomous vehicle.

3. The control system of claim 1, wherein the processor is configured to determine whether the autonomous vehicle is stopped for more than a predetermined time period by monitoring the autonomous vehicle, and when the processor concludes that the autonomous vehicle is stopped for more than the predetermined time period, to request checking whether remote driving is required to the autonomous vehicle.

4. The control system of claim 1, wherein the processor is configured to generate a remote driving path for moving the autonomous vehicle from a current position of the autonomous vehicle to a safety zone, and to determine an entire shaded section of the remote driving path.

5. The control system of claim 4, wherein the processor is configured to determine whether a sensing range of a closed-circuit television (CCTV) around the autonomous vehicle includes the entire shaded section.

6. The control system of claim 5, wherein when the sensing range of the CCTV includes the entire shaded section, the processor is configured to generate the remote driving path of the autonomous vehicle according to image data of the CCTV.

7. The control system of claim 1, wherein the processor is configured to request cooperation to a surrounding vehicle positioned around the autonomous vehicle.

8. The control system of claim 7, wherein when approval of the cooperation request is reached from the surrounding vehicle, the processor is configured to generate a driving path of the surrounding vehicle and to transmit the driving path to the surrounding vehicle.

9. The control system of claim 8, wherein the processor is configured to:
determine an entire shaded section on a remote driving path of the autonomous vehicle, and
generate the driving path of the surrounding vehicle so that a sensing range of the surrounding vehicle includes the entire shaded section.

10. The control system of claim 9, wherein when the surrounding vehicle is a vehicle that drives autonomously, the processor is configured:
to divide the remote driving path of the autonomous vehicle into a plurality of sections, and
to generate the driving path of the surrounding vehicle to be synchronized with the sections to transmit the driving path to the surrounding vehicle.

11. The control system of claim 9, wherein when the surrounding vehicle is a vehicle that drives autonomously, the processor is configured to control the surrounding vehicle to be positioned side by side in a lane next to the autonomous vehicle and to start simultaneously.

12. The control system of claim 9, wherein when the surrounding vehicle is a general driving vehicle which is directly driven by a driver, the processor is configured:
to generate predetermined sections of the remote driving path of the autonomous vehicle as a driving path of the general vehicle, and
to control the general vehicle to start driving first and the autonomous vehicle to start driving after a predetermined time period.

13. The control system of claim 1, wherein when a sensor of the autonomous vehicle malfunctions due to an accident of the autonomous vehicle, the processor is configured to generate a remote driving path for moving the autonomous vehicle from an accident point to a safety zone.

14. An autonomous vehicle comprising
a processor configured to request remote driving control to a control system to transmit information related to a shaded section, and to receive a remote driving path from the control system and to follow the remote driving path when a shaded section occurs due to a sensor failure during autonomous driving of the autonomous vehicle.

15. The autonomous vehicle of claim 14, wherein when a sensor of the autonomous vehicle malfunctions due to an accident of the autonomous vehicle, the processor is configured to move the autonomous vehicle from an accident point to a safe zone depending on the remote driving path received from the control system.

16. A remote control method for an autonomous vehicle, the remote control method comprising:
receiving, by a processor, a remote driving control request and information related to a shaded section due to a sensor failure from the autonomous vehicle; and
controlling, by the processor, remote driving of the autonomous vehicle by obtaining information related to the shaded section according to surrounding information of the autonomous vehicle.

17. The remote method of controlling claim 16, wherein the controlling of the remote driving includes:
generating, by the processor, a remote driving path for moving the autonomous vehicle from a current position of the autonomous vehicle to a safety zone, and determining an entire shaded section of the remote driving path; and
determining, by the processor, whether a sensing range of a closed-circuit television (CCTV) around the autonomous vehicle includes the entire shaded section.

18. The remote method of controlling claim 17, wherein the controlling of the remote driving includes:
when the sensing range of the CCTV includes the entire shaded section,
generating, by the processor, the remote driving path of the autonomous vehicle according to image data of the CCTV.

19. The remote method of controlling claim 18, wherein the controlling of the remote driving includes:
when the sensing range of the CCTV does not include the entire shaded section,
requesting, by the processor, cooperation to a surrounding vehicle positioned around the autonomous vehicle; and
generating, by the processor, a driving path of the surrounding vehicle and transmitting, by the processor, the driving path to the surrounding vehicle when approval of the cooperation request is reached from the surrounding vehicle.

20. The remote method of controlling claim 19, wherein the controlling of the remote driving includes:
determining, by the processor, an entire shaded section on the remote driving path of the autonomous vehicle, and generating, by the processor, the driving path of the surrounding vehicle so that a sensing range of the surrounding vehicle includes the entire shaded section;
dividing, by the processor, the remote driving path of the autonomous vehicle into a plurality of sections, and generating, by the processor, a driving path of the surrounding vehicle to be synchronized with the sections when the surrounding vehicle is a vehicle that drives autonomously;
when the surrounding vehicle is a general driving vehicle which is directly driven by a driver,
generating, by the processor, predetermined sections of the remote driving path of the autonomous vehicle as a driving path of the general vehicle; and
controlling, by the processor, the general vehicle to start driving first and the autonomous vehicle to start driving after a predetermined time period.
